(19) United States
(12) Patent Application Publication
(10) Pub. No.: US 2019/0002178 A1
(43) Pub. Date: Jan. 3, 2019

(54) Controlled-Atmosphere Flexible Packaging and Use of Alicyclic Polyolefin Barrier Material for Controlled Atmosphere Products

(71) Applicant: Topas Advanced Polymers, Inc., Florence, KY (US)

(72) Inventors: Paul D. Tatarka, Union, KY (US); Timothy M. Kneale, Florence, KY (US)

(21) Appl. No.: 15/638,480

(22) Filed: Jun. 30, 2017

(51) Int. Cl. B65D 81/26; B65D 81/28; B65F 1/00; B32B 27/32; B32B 27/34; D01F 6/04

(52) U.S. Cl. CPC B65D 81/268; B65D 81/28; D01F 6/04; B32B 27/32; B32B 27/34; B65F 1/0006

(57) ABSTRACT

Controlled-atmosphere flexible packaging includes a multilayer polymeric film heat-sealed to form an enclosure, with an alicyclic polyolefin barrier layer forming a heat-seal and a controlled atmosphere retained within said enclosure. The controlled atmosphere is selected from inert gas atmospheres, such as nitrogen atmospheres and the packaging is used for snack foods in order to extend shelf-life. In other embodiments, an alicyclic barrier component improves performance of gas barrier structures for a variety of applications.

### TECHNICAL FIELD

The present invention relates to controlled atmosphere and inflated structures utilizing an alicyclic polyolefin containing barrier material. Such structures are useful in food packaging with nitrogen or other inert atmospheres.

### BACKGROUND

Oxygen-sensitive consumable snack products such as nuts are often packaged in a bag inflated with nitrogen. The benefits are two-fold: the nitrogen atmosphere prevents oxidation of the product, promoting freshness and the positive gauge pressure inside the bag cushions the product and reduces breakage during handling. A typical snack bag is made up of multiple layers of polymer materials laminated together, for example: biaxially oriented polypropylene (BOPP) on the inside, low-density polyethylene (LDPE) in the middle, another middle layer of BOPP, and an outer layer of Surlyn®, a thermoplastic ionomer resin. Each layer performs a specific function. BOPP is an excellent moisture barrier (so it keeps moisture away from the packaged product), and it's also resistant to oils and grease. LDPE is also resistant to vegetable oils, and both LDPE and Surlyn® are strong and flexible. BOPP has a high oxygen transmission rate, and if it were used alone, it would permit oxygen into the package. This would oxidize the fats or oils in nuts or other products causing spoilage. This is the reason that an extremely thin layer of aluminum is usually applied to one of the layers, a process called metallizing. The metallized layer is about 400 to 500 Angstroms thick, which is three times thinner than the thinnest commercial foils. Besides providing an effective barrier to atmospheric gases and aroma constituents, metallizing also prevents light from entering. Light is undesirable since it may also be a catalyst for the oxidation of fats and oils. LDPE is known for its flexibility, moisture protection, toughness, chemical resistance, lightweight, sealing properties, and low cost. However, LDPE cannot be used alone because of its poor gas resistance, inability to retain ink, and its strong tendency to develop a static charge that may attract dust, which can be unsightly on a retail shelf. Surlyn® delivers outstanding impact toughness, abrasion resistance, and chemical resistance in a variety of consumer and industrial products, is heat-sealable and holds ink well.

Alicyclic polyolefins such as cyclic olefin copolymers (COCs) are known to be useful in a variety of packaging applications, including their use as heat-sealing layers. See U.S. Pat. No. 7,288,316 to Jester. See, also, U.S. Pat. No. 8,092,877, also to Jester, which discloses COCs as an aroma barrier. Also noted is United States Patent Application Publication No. US2006/0009610 of Hayes.

United States Patent Application Publication No. US2009/0067760 of Shelley et al. relates to bags with odor management capabilities and mentions COCs as a barrier material, ¶¶ [0101], [0106], along with an extensive listing of other materials. So, also, United States Patent Application Publication No. US2012/0067750 of Bennett et al. mentions COCs in connection with modified atmosphere rigid packaging, ¶ [0029]. The packages are in the form of a container with a base and a cover.

It has been found in accordance with the present invention that the remarkable barrier properties of alicylic polyolefin barrier films with respect to oxygen, nitrogen and helium enable their use in connection with a variety of controlled atmosphere and inflated structures.

### SUMMARY OF INVENTION

In one aspect of the present invention there is provided controlled-atmosphere flexible packaging comprising a multilayer polymeric film heat-sealed to form an enclosure where the multilayer film includes an alicyclic polyolefin barrier layer forming a heat-seal and a controlled atmosphere retained within said enclosure. The controlled atmosphere is suitably selected from inert gas atmospheres such as nitrogen, helium, carbon dioxide, argon and mixtures of these gasses. In one preferred embodiment, the inert gas atmosphere consists essentially of nitrogen under positive gauge pressure.

A particularly preferred application is the use of the inventive films as a barrier and/or sealing layer for multilayer, nitrogen-filled flexible packaging for oxygen-sensitive snack foods such as nuts and meat snacks based on beef, pork or fish, as well as potato chips, corn chips, cheese puffs, tortilla chips and various types of crackers and cookies. A snack packaging bag may be formed from the multilayer film with a back heat seal and a pair of transverse heat seals thereby defining the enclosure, wherein the back heat seal and the transverse heat seals are formed with alicyclic barrier polyolefin.

In another aspect of the invention there is provided an improvement for a controlled atmosphere enclosure having one or more polymeric components, the improvement comprising utilizing an alicyclic polyolefin barrier polymer. The controlled atmosphere may be selected from positive gauge pressure atmospheres, negative gauge pressure atmospheres, inert gas atmospheres, controlled humidity atmospheres, encapsulated atmospheres or combinations thereof.

Controlled atmosphere products which may be made with alicyclic barrier components or layers thus include snack bags, vacuum packed products, bubble wrap, air pillows for packaging and tires.

Further aspects and advantages of the invention are described below.

### BRIEF DESCRIPTION OF DRAWINGS

The invention is described in detail below with reference to the drawings wherein like numerals designate similar parts and wherein:

FIG. 1 is a plot of nitrogen permeability versus water vapor permeability for a variety of films, including COC films;

FIG. 2 is a plot of nitrogen permeability versus water vapor permeability for a variety of elastomer films, including COC elastomer films;

FIG. 3 is a plot of oxygen permeability versus water vapor permeability for a variety of elastomer films, including COC elastomer films;

FIG. 4 is a plot of helium permeability versus water vapor permeability for various polymer films;

FIG. 5 is a schematic diagram of the sidewall of a nitrogen inflated bag of the invention which is used for food packaging; and

FIG. 6 is a schematic diagram illustrating bag fabrication.

### DETAILED DESCRIPTION

The invention is described in detail below in connection with the Figures for purposes of illustration only. The invention is defined in the appended claims. Terminology used herein is given its ordinary meaning consistent with the exemplary definitions set forth herein; % means weight percent or mol % as indicated, or in the absence of an indication, refers to weight percent. mils refers to thousandths of an inch and so forth.

“Alicyclic polyolefin composition” and like terminology means a composition including a CBC polymer, a COC polymer or a COP polymer. An alicyclic polyolefin barrier layer may be formed of a CBC, COC or COP polymer optionally melt-blended with polyethylene or polypropylene or other polymers. The barrier layer may be laminated or coextruded with other layers. Preferably, an alicyclic polyolefin composition consists essentially of CBC, COC and COP material.

An “amorphous alicyclic polyolefin composition” means an alicyclic polyolefin composition including one or more amorphous or substantially amorphous CBC, COC or COP polymers. Preferably, the amorphous alicyclic polyolefin composition consists essentially of one or more amorphous or substantially amorphous CBC, COC or COP polymers.

“Amorphous cycloolefin polymer” and like terminology refers to a COP or COC polymer which exhibits a glass transition temperature, but does not exhibit a crystalline melting temperature nor does it exhibit a clear x-ray diffraction pattern.

“Amorphous cycloolefin polymer composition” and like terminology refers to a composition containing one or more amorphous cycloolefin polymers. Preferably, an amorphous cycloolefin polymer composition consists essentially of one or more amorphous cycloolefin polymers.

“CBC polymer” and like terminology refers to cyclic block copolymers prepared by hydrogenating a vinyl aromatic/conjugated diene block copolymer as hereinafter described.

A “substantially amorphous” CBC material means that at least 95 mol % of the vinyl aromatic double bonds are hydrogenated and at least 97 mol % of the double bonds in the diene blocks are hydrogenated.

“COC” polymer and like terminology refers to a cycloolefin copolymer prepared with acyclic olefin monomer such as ethylene or propylene and cycloolefin monomer by way of addition copolymerization.

“COP polymer” and like terminology refers to a cycloolefin containing polymer prepared exclusively from cycloolefin monomer, typically by ring opening polymerization.

“Consisting essentially of” and like terminology refers to the recited components and excludes other ingredients which would substantially change the basic and novel characteristics of the composition or article. Unless otherwise indicated or readily apparent, a composition or article consists essentially of the recited components when the composition or article includes 90% or more by weight of the recited components. That is, the terminology excludes more than 10% unrecited components.

“Controlled atmosphere” refers to atmospheres other than ambient air which may be selected from positive gauge pressure atmospheres used to inflate structures, negative gauge pressure atmospheres used for vacuum packing, inert gas atmospheres, controlled humidity atmospheres or combinations thereof. In some embodiments such as bubble wrap, a controlled atmosphere merely refers to an enclosed air bubble isolated from the surroundings. Controlled atmosphere products typically include packaged goods such as nuts, chips, crackers, trail mix, cookies and the like, packaged in an inert atmosphere as well as bubble wrap, air pillows, tires and so forth.

“Glass transition temperature” or Tg, of a composition refers to the temperature at which a composition transitions from a glassy state to a viscous or rubbery state. Glass transition temperature may be measured in accordance with ASTM D3418 or equivalent procedure.

“Heat-sealed” refers to a melt-bond of polymeric layer(s) which may be with or without a bonding agent.

Inert atmospheres refers to atmospheres with an oxygen content below that of air which has an oxygen content of about 0.28 g/l at 20° C. and 1 atmosphere. Inert gasses which make up an inert atmosphere include nitrogen, noble gasses such as argon and helium, carbon dioxide and the like. Inert atmospheres also include vacuum atmospheres below ambient pressures as well as mixtures of inert gasses such as mixtures of nitrogen with argon or helium and so forth.

“Melting temperature” refers to the crystalline melting temperature of a semi-crystalline composition.

A “multilayer polymeric film” refers to a laminated or coextruded multilayer structure formed with a plurality of distinct polymeric layers.

“Metallized” or like terminology refers to a polymer film layer provided with a metal coating of aluminum or other metal including oxides thereof.

Polyethylene polymer(s) and like terminology refers to a polymer, including ethylene derived repeat units. Typically, ethylene polymers are more than 80 wt % ethylene and are semi-crystalline.

A “polymeric component” refers to a polymer structure including polyethylenes, polypropylenes, polyesters, polyamides, polystyrenes, rubber materials and so forth.

Polypropylene polymer(s) and like terminology refers to polymers comprising polypropylene repeat units. Most polypropylene polymers are more than 80 wt. % polypropylene except that polypropylene copolymers with ethylene may comprise less propylene than that. Polypropylene polymers are semi-crystalline.

A “semi-crystalline polyolefin composition” includes one or more polyolefin polymers, typically a polyethylene polymer or a polypropylene polymer. The composition exhibits a crystalline melting temperature.

“Predominantly”, “primarily” and like terminology when referring to a component in a composition means the component is present in an amount of more than 50% by weight of the composition.

Tie layers, adhesives or other bonding agents may be added between layers, if so desired. Suitable bonding agents include Bynel® resins available from DuPont. Other products such as Surlyn® monomers, Nucrel® acid copolymers and Entira™ coat resins may be employed as bonding agents, as well.

These resins employ a variety of chemistries and functionalities along with various modifiers and additives. Acid functionalities, for example, provide adhesion to metallized layers, paper, nylon and ionomers. Ethylene vinyl acetate resins are useful for bonding a wide range of polymers, including polyethylene terephthalate, polypropylene and polystyrene. Alicyclic polyolefin resins bond well with other polyolefins and an adhesive therebetween is not ordinarily required.

### Amorphous Cycloolefin Containing Polymers and Polymer Compositions

Cycloolefins are mono- or polyunsaturated polycyclic ring systems, such as cycloalkenes, bicycloalkenes, tricycloalkenes or tetracycloalkenes. The ring systems can be monosubstituted or polysubstituted. Preference is given to cycloolefins of the formulae I, II, III, IV, V or VI, or a monocyclic olefin of the formula VII:

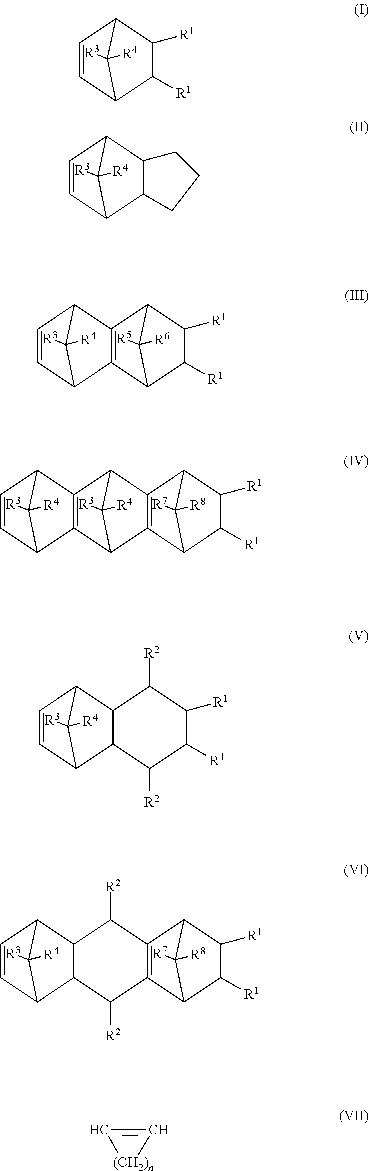

wherein R¹, R², R³, R⁴, R⁵, R⁶, R⁷ and R⁸ are the same or different and are H, a C₆-C₂₀-aryl or C₁-C₂₀-alkyl radical or a halogen atom, and n is a number from 2 to 10.

Specific cycloolefin monomers are disclosed in U.S. Pat. No. 5,494,969 to Abe et al. Cols. 9-27, for example the following monomers:

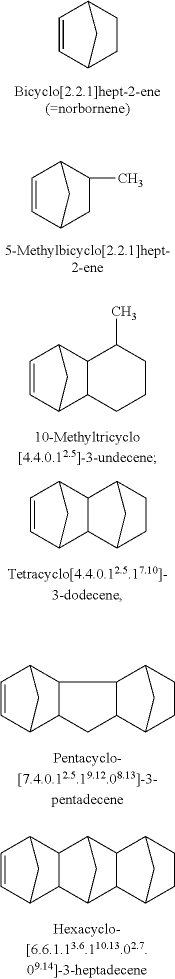

and so forth. The disclosure of U.S. Pat. No. 5,494,969 to Abe et al., Cols. 9-27, is incorporated herein by reference.

U.S. Pat. No. 6,068,936 and U.S. Pat. No. 5,912,070 disclose several cycloolefin polymers and copolymers, the disclosures of which are incorporated herein in their entirety by reference. Cycloolefin polymers useful in connection with the present invention can be prepared with the aid of transition-metal catalysts, e.g. metallocenes. Suitable preparation processes are known and described, for example, in DD-A-109 225, EP-A-0 407 870, EP-A-0 485 893, U.S. Pat. Nos. 6,489,016, 6,008,298, as well as the aforementioned U.S. Pat. Nos. 6,608,936, and 5,912,070, the disclosures of which are all incorporated herein in their entirety by reference. Molecular weight regulation during the preparation can advantageously be effected using hydrogen. Suitable molecular weights can also be established through targeted selection of the catalyst and reaction conditions. Details in this respect are given in the abovementioned specifications.

Particularly preferred cycloolefin copolymers include cycloolefin monomers and acyclic olefin monomers, i.e. the above-described cycloolefin monomers can be copolymerized with suitable acyclic olefin comonomers. A preferred comonomer is selected from the group consisting of ethylene, propylene, butylene and combinations thereof. A particularly preferred comonomer is ethylene. Preferred COCs contains about 10-80 mole percent of the cycloolefin monomer moiety and about 90-20 weight percent of the olefin moiety (such as ethylene). Cycloolefin copolymers which are suitable for the purposes of the present invention typically have a mean molecular weight M_{w} in the range from more than 200 g/mol to 400,000 g/mol. COCs can be characterized by their glass transition temperature, Tg, which is generally in the range from 20° C. to 200° C., preferably in the range from 60° C. to 145° C. when used in connection with the present invention.

Properties for several COC grades are summarized in Table 1.

TABLE 1
COC Properties

| | COC- | COC- | COC- | COC- | E- |
|---|---|---|---|---|---|
| Property | 65 | 78 | 110 | 138 | 140 |
| Density (kg/m³) | 1010 | 1010 | 1010 | 1020 | 940 |
| ISO 1183 | | | | | |
| Melt Flow Rate | 5.5 | 11.0 | 9.2 | 0.9 | 2.7 |
| (dg/min); | 0.9 | 1.9 | 1.7 | <0.1 | 0.9 |
| 230° C., 2.16 kg load | | | | | |
| 190° C., 2.16 kg load | | | | | |
| ISO 1133 (calculated w/ | | | | | |
| melt density 0.92) | | | | | |
| Glass Transition | 65 | 78 | 110 | 138 | 6 |
| Temperature (° C.) | | | | | |
| (10° C./min) | | | | | |
| ISO 11357-1, -2, -3 | | | | | |
| Tensile Modulus (MPa) | 2300 | 2400 | 2700 | 2900 | 50 |
| ISO 527-1, -2 | | | | | |
| Water Adsorption (%) | 0.01 | 0.01 | 0.01 | 0.01 | |
| (23° C.- sat) | | | | | |
| ISO 62 | | | | | |
| Water Vapor | 0.8 | 0.8 | 1.0 | 1.3 | 4.6 |
| Permeability | | | | | |
| (g-100 μm/m² day) | | | | | |
| {38° C. 50% RH} | | | | | |
| ISO 15106-3 | | | | | |
| Haze (%) | <2 | <2 | <4 | <1 | <1 |
| ISO 14782 | | | | | |
| {50 μm cast film} | | | | | |
| Gloss at 60° | >120 | >120 | >120 | >120 | >120 |
| ISO 2813 | | | | | |
| {50 μm cast film} | | | | | |

The various grades of COC may be melt-blended to promote compatibility with the any other polymer employed in a blend in terms of melt viscosities and temperatures.

Blends used in connection with the invention may be prepared by any suitable method, including solution blending, melt compounding by coextrusion prior to injection molding and/or “salt and pepper” pellet blending to an injection molding apparatus and the like.

### Cycloolefin Copolymer Elastomers

COC elastomers such as E-140 are elastomeric cyclic olefin copolymers also available from TOPAS Advanced Polymers. E-140 polymer features two glass transition temperatures, one of about 6° C. and another glass transition below −90° C. as well as a crystalline melting point of about 84° C. Unlike completely amorphous TOPAS COC grades, COC elastomers typically contain between 10 and 30 percent crystallinity by weight. Typical properties of E-140 grade appears in Table 2:

TABLE 2
E-140 Elastomer Properties

| Property | Value | Unit | Test Standard |
|---|---|---|---|
| Physical Properties | | | |
| Density | 940 | kg/m³ | ISO 1183 |
| Melt volume rate (MVR) - | 3 | cm³/10 min | ISO 1133 |
| @ 2.16 kg/190° C. | | | |
| Melt volume rate (MVR) - | 12 | cm³/10 min | ISO 1133 |
| @ 2.16 kg/260° C. | | | |
| Hardness, Shore A | 89 | — | ISO 868 |
| WVTR - @ 23° C./85 RH | 1.0 | g*100 μm/m² * | ISO 15106-3 |
| | | day | |
| WVTR - @ 38° C./90 RH | 4.6 | g*100 μm/m² * | ISO 15106-3 |
| | | day | |
| Mechanical Properties | | | |
| Tensile stress at break | >19 | MPa | ISO 527-T2/1A |
| (50 mm/min) | | | |
| Tensile modulus | 44 | MPa | ISO 527-T2/1A |
| (1 mm/min) | | | |
| Tensile strain at break | >450 | % | ISO 527-T2/1A |
| (50 mm/min) | | | |
| Tear Strength | 47 | kN/m | ISO 34-1 |
| Compression set - @ | 35 | % | ISO 815 |
| 24 h/23° C. | | | |
| Compression set - @ | 32 | % | ISO 815 |
| 72 h/23° C. | | | |
| Compression set - @ | 90 | % | ISO 815 |
| 24 h/60° C. | | | |
| Thermal Properties | | | |
| Tg - Glass transition temperature | 6 | ° C. | DSC |
| (10° C./min) | <−90 | | |
| Tₘ - Melt temperature | 84 | ° C. | DSC |
| Vicat softening temperature, | 64 | ° C. | ISO 306 |
| VST/A50 | | | |

As seen above, E-140 has multiple glass transitions (Tg); one occurs at less than −90° C. and the other occurs in the range from −10° C. to 15° C. Details on COC elastomers appear in U.S. Pat. No. 9,452,593.

Generally, suitable partially crystalline elastomers of norbornene and ethylene include from 0.1 mol % to 20 mol % norbornene, have a glass transition temperature of less than 30° C., a crystalline melting temperature of less than 125° C. and 40% or less crystallinity by weight. Particularly preferred elastomers exhibit a crystalline melting temperature of less than 90° C. and more than 60° C. Cycloolefin elastomers useful in connection with the present invention may be produced in accordance with the following: U.S. Pat. Nos. 5,693,728 and 5,648,443 to Okamoto et al.; European Patent Nos. 0 504 418 and 0 818 472 (Idemitsu Kosan Co., Ltd. and Japanese Patent No. 3350951, also of Idemitsu Kusan Co., Ltd., the disclosures of which are incorporated herein by reference.

Other norbornene/α-olefin copolymer elastomers are described in U.S. Pat. No. 5,837,787 to Harrington et al., the disclosure of which is incorporated herein by reference.

### Cyclic Block Copolymer

Cyclic block copolymer (CBC) is prepared by substantially fully hydrogenating a vinyl aromatic/conjugated diene block copolymer such as a styrene-butadiene block copolymer:

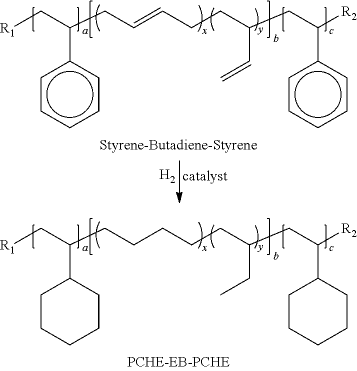

These polymers may be tailored by adjusting the ratio of poly(cyclohexylethylene)(PCHE) and ethylene-co-1-butene (EB) to provide a range of properties. See U.S. Pat. No. 9,103,966.

Prior to hydrogenation, the vinyl aromatic/conjugated diene block copolymer may have any known architecture, including distinct block, tapered block, and radial block. Distinct block structures that include alternating vinyl aromatic blocks and conjugated diene blocks yield preferred results, especially when such block structures yield triblock copolymers or pentablock copolymers, in each case with vinyl aromatic end blocks. Typical vinyl aromatic monomers include styrene, alpha-methylstyrene, all isomers of vinyl toluene (especially para-vinyl toluene), all isomers of ethyl styrene, propyl styrene, butyl styrene, vinyl biphenyl, vinyl naphthalene, vinyl anthracene and the like, or mixtures thereof. The block copolymers can contain one or more than one polymerized vinyl aromatic monomer in each vinyl aromatic block. The vinyl aromatic blocks preferably comprise styrene, more preferably consist essentially of styrene, and still more preferably consist of styrene.

The conjugated diene blocks may comprise any monomer that has two conjugated double bonds. Illustrative, but non-limiting, examples of conjugated diene monomers include butadiene, 2-methyl-1,3-butadiene, 2-methyl-1,3-pentadiene, isoprene, or mixtures thereof. As with the vinyl aromatic blocks, the block copolymers may contain one (for example, butadiene or isoprene) or more than one (for example, both butadiene and isoprene). Preferred conjugated diene polymer blocks in the block copolymers may, prior to hydrogenation, comprise polybutadiene blocks, polyisoprene blocks or mixed polybutadiene/polyisoprene blocks. While a block copolymer may, prior to hydrogenation, include one polybutadiene block and one polyisoprene block, preferred results follow with block copolymers that, prior to hydrogenation, have conjugated diene blocks that are solely polybutadiene blocks or solely polyisoprene blocks. A preference for a single diene monomer stems primarily from manufacturing simplicity. In both cases, the microstructure of diene incorporation into the polymer backbone can be controlled to achieve a CBC polymer that is substantially or fully amorphous.

Illustrative preferred vinyl aromatic/conjugated diene block copolymers wherein each vinyl aromatic block comprises styrene (S) and each conjugated diene block comprises butadiene (B) or isoprene (I) include SBS and SIS triblock copolymers and SBSBS and SISIS pentablock copolymers. While the block copolymer may be a triblock copolymer or, more preferably a pentablock copolymer, the block copolymer may be a multiblock that has one or more additional vinyl aromatic polymer blocks, one or more additional conjugated diene polymer blocks or both one or more additional vinyl aromatic polymer blocks and one or more additional conjugated diene polymer blocks, or a star block copolymer (for example, that produced via coupling). One may use a blend of two block copolymers (for example, two triblock copolymers, two pentablock copolymers or one triblock copolymer and one pentablock copolymer) if desired. One may also use two different diene monomers within a single block, which would provide a structure that may be shown as, for example, SIBS. These representative structures illustrate, but do not limit, block copolymers that may be suitable for use as the first polymer in an embodiment of this invention.

“Substantially fully hydrogenated” means that at least 95 percent of the double bonds present in vinyl aromatic blocks prior to hydrogenation are hydrogenated or saturated and at least 97 percent of double bonds present in diene blocks prior to hydrogenation are hydrogenated or saturated. By varying the relative length of the blocks, total molecular weight, block architecture (e.g., diblock, triblock, pentablock, multi-armed radial block, etc.) and process conditions, various types of nanostructure morphology can be obtained from this block copolymer and thereby modify the optical properties of the major phase. Specific, non-limiting examples include lamellar morphology, bi-continuous gyroid morphology, cylinder morphology, and spherical morphology, etc. The morphology and microphase separation behavior of a block copolymer is well known and may be found, for example, in The Physics of Block Copolymers by Ian Hamley, Oxford University Press, 1998. Particularly preferred CBC polymers are those having an amount of styrene from 65 wt % to less than 90 wt % and an amount of conjugated diene from more than 10 wt % to 35 wt %, prior to hydrogenation.

Number average molecular weight (Mn) and weight average molecular weight (Mw) can both be used to describe the CBC. Because these polymers tend to have very narrow molecular weight polydispersities, the difference between Mn and Mw is minimal. The ratio of Mw to Mn is typically 1.1 or less. In fact, in some cases the number average molecular weight and the number average molecular weight will be virtually the same.

Methods of making block copolymers are well known in the art. Typically, block copolymers are made by anionic polymerization, examples of which are cited in Anionic Polymerization: Principles and Practical Applications, H. L. Hsieh and R. P. Quirk, Marcel Dekker, New York, 1996. In one embodiment, block copolymers are made by sequential monomer addition to a carbanionic initiator such as sec-butyl lithium or n-butyl lithium. In another embodiment, the copolymer is made by coupling a triblock material with a divalent coupling agent such as 1,2-dibromoethane, dichlorodimethylsilane, or phenylbenzoate. In this embodiment, a small chain (less than 10 monomer repeat units) of a conjugated diene polymer can be reacted with the vinyl aromatic polymer coupling end to facilitate the coupling reaction. Vinyl aromatic polymer blocks are typically difficult to couple, therefore, this technique is commonly used to achieve coupling of the vinyl aromatic polymer ends. The small chain of diene polymer does not constitute a distinct block since no microphase separation is achieved. Coupling reagents and strategies which have been demonstrated for a variety of anionic polymerizations are discussed in Hsieh and Quirk, Chapter 12, pp. 307-331. In another embodiment, a difunctional anionic initiator is used to initiate the polymerization from the center of the block system, wherein subsequent monomer additions add equally to both ends of the growing polymer chain. An example of such a difunctional initiator is 1,3-bis(1-phenylethenyl)benzene treated with organo-lithium compounds, as described in U.S. Pat. Nos. 4,200,718 and 4,196,154.

After preparation of the block copolymer, the copolymer is hydrogenated to remove sites of unsaturation in both the conjugated diene polymer block and the vinyl aromatic polymer block segments of the copolymer. Any method of hydrogenation can be used and such methods typically include the use of metal catalysts supported on an inorganic substrate, such as Pd on BaSO₄ (U.S. Pat. No. 5,352,744) and Ni on kieselguhr (U.S. Pat. No. 3,333,024). Additionally, soluble, homogeneous catalysts such those prepared from combinations of transition metal salts of 2-ethylhexanoic acid and alkyl lithiums can be used to fully saturate block copolymers, as described in Die Makromolekulare Chemie, Volume 160, pp. 291, 1972. The copolymer hydrogenation can also be achieved using hydrogen and a heterogeneous catalyst such as those described in U.S. Pat. Nos. 5,352,744, 5,612,422 and 5,645,253.

“Level of hydrogenation” and like terms means the percentage of the original unsaturated bonds which become saturated upon hydrogenation. The level of hydrogenation in hydrogenated vinyl aromatic polymers is determined using UV-VIS spectrophotometry, while the level of hydrogenation in hydrogenated diene polymers is determined using proton NMR.

In one embodiment the composition comprises a hydrogenated block copolymer of a vinyl aromatic and a conjugated diene in which the block copolymer is a penta-block copolymer comprising three blocks of hydrogenated vinyl aromatic polymer and two blocks of conjugated diene polymer. The hydrogenated penta-block copolymer comprises less than 90 weight percent hydrogenated vinyl aromatic polymer blocks, based on the total weight of the hydrogenated block copolymer, and has an aromatic and diene hydrogenation level of at least 95 percent.

CBC's are available from USI under the product designation Puratran™ Some typical polymers have the properties enumerated below in Table 3.

TABLE 3
CBC Properties

| | | | | | |
|---|---|---|---|---|---|
| | | Test Method | Puratran ™ | Puratran ™ | Puratran ™ |
| Properties | Unit | (ASTM) | HP010 | HP030 | UHT081 |

General Properties

| | | | | | |
|---|---|---|---|---|---|
| Density | g/cm³ | D792 | 0.94 | 0.94 | 0.93 |
| Water uptake | % | D670 | <0.01 | <0.01 | <0.01 |
| Melt flow rate(1.2 kg. 260° C.) | g/10 min | D1238 | 54.6 | 5.5 | 0.04 |
| Melt flow rate(1.2 kg. 280° C.) | g/10 min | D1238 | 136.3 | 21.0 | 0.15 |
| Melt flow rate(1.2 kg. 300° C.) | g/10 min | D1238 | 296.0 | 62.5 | 1.40 |

Thermal Properties

| | | | | | |
|---|---|---|---|---|---|
| Tg (TMA) | ° C. | USI method | 117 | 129 | 133 |
| DTUL (455kPa) | ° C. | D648 | 102 | 115 | 128 |
| Vicat softening point (1 kg) | ° C. | D1525 | 117 | 128 | 134 |

Mechanical Properties

| | | | | | |
|---|---|---|---|---|---|
| Flexural strength | MPa | D790 | 71.7 | 74.2 | 59.3 |
| Flexural modulus | GPa | D790 | 2.5 | 2.6 | 2.2 |
| Y.P. Tensile strength | MPa | D638 | 33.7 | 33.5 | 27.6 |
| B.P. Tensile strength | MPa | D638 | 32.9 | 33.6 | 26.1 |
| Tensile modulus | GPa | D638 | 2.6 | 2.6 | 2.2 |
| Elongation | % | D638 | 3.7 | 7.6 | 6.0 |
| Izod Impact strength | J/m | D256 | 29.5 | 34.1 | 36.0 |

### Polyolefins

Polyolefins are high molecular weight hydrocarbons. They include: low-density; linear low-density and high-density polyethylene; polypropylene; polypropylene copolymer as well as other polymers. See Kirk-Othmer Encyclopedia of Chemical Technology, 3^{rd} ed., Vol. 16, pp. 385-499, Wiley 1981. All are break-resistant, nontoxic, and non-contaminating. “Partially crystalline” polyolefins, and like terminology refers to a partially crystalline material which contains polyolefin repeat units and exhibits a (crystalline) melting point. A partially crystalline composition contains or consists essentially of a partially crystalline polymer.

“Polypropylene” includes thermoplastic resins made by polymerizing propylene with suitable catalysts, generally aluminum alkyl and titanium tetrachloride mixed with solvents. This definition includes all the possible geometric arrangements of the monomer unit, such as: with all methyl groups aligned on the same side of the chain (isotactic), with the methyl groups alternating (syndiotactic), all other forms where the methyl positioning is random (atactic), and mixtures thereof. Polypropylene copolymer (PPCO) is essentially a linear copolymer with ethylene and propylene repeat units. It combines some of the advantages of both polymers. PPCO is typically more than 80 wt % polypropylene units, but may be made with less propylene and more ethylene in some cases. Polypropylenes do exhibit some strain hardening behavior, but ISBM performance may be greatly enhanced with the addition of alicyclic polyolefins.

Polyethylenes are particularly useful because of their processability, mechanical and optical properties, as well as compatability with the polymer blends of the present invention. Polyethylenes which are useful include commercially available polymers and copolymers such as low density polyethylene, linear low density polyethylene (LLDPE), intermediate density polyethylene (MDPE) and high density polyethylene (HDPE).

HDPE is polyethylene having a density in the range of 0.93 g/cc to 0.98 g/cc, typically greater or equal to 0.941 g/cc. HDPE has a low degree of branching and thus stronger intermolecular forces and tensile strength. HDPE can be produced, for example, by chromium/silica catalysts, Ziegler-Natta catalysts or single site catalysts. The lack of branching is ensured by an appropriate choice of catalyst (e.g. Chromium catalysts or Ziegler-Natta catalysts) and reaction conditions. In some embodiments, it is preferred to use bimodal HDPE as is disclosed in United States Patent Application Publication No. US 2012/0282422, entitled “Bimodal Polyethylene for Injection Stretch Blow Moulding Applications”, of Boissiere et al. and U.S. Pat. No. 8,609,792 of Vantomme et al. entitled “Bimodal Polyethylene for Blow Moulding Applications”, as well as United States Patent Application Publication Nos.: US 2012/0245307; US 2012/0252988; the disclosures of which are incorporated herein by reference. In general, the molecular weight of the HDPE and other partially crystalline polyolefins employed is anywhere from 28,000 to 280,000 Daltons. Typical properties for unimodal and bimodal HDPE appear in Table 4.

TABLE 4
Comparison of Bimodal and Unimodal HDPE

| | | Unimodal | |
|---|---|---|---|
| | | Copolymer | Unimodal |
| | Bimodal | Purpose | Homopolymer |
| | Copolymer | Blow-Molding | Blow-Molding |
| Melt Index (g/10 min.)- | 0.45 | 0.3 | 0.7 |
| ASTM D1238 | | | |
| Density (g/cc)-ASTM | 0.957 | 0.955 | 0.962 |
| D792 | | | |
| ESCR @ 10% (hrs)- | 300 | 60 | 15 |
| ASTM D1693, Cond. B | | | |
| Flex. Modulus (psi)- | 170 | 150 | 225 |
| ASTM D790 | | | |

HDPE properties are density dependent. Table 5 summarizes melting point and heat distortion temperature of HDPE at two densities.

TABLE 5
HDPE Thermal Properties versus Density

| Tₘ (° C.) | Heat Distortion Temp. (° C.) | Density (g/cc) |
|---|---|---|
| 130 | 79 | 0.952 |
| 137 | 91 | 0.965 |

### Polyamides

Polyamides”, “copolyamides” and like terminology refers to compositions containing polyamides. Exemplary polyamides and polyamide compositions are described in Kirk-Othmer, Encyclopedia of Chemical Technology, Vol. 18, pp. 328-371 (Wiley 1982), the disclosure of which is incorporated by reference. Polyamides are frequently referred to as nylons, the most prevalent of which are nylon 6 and nylon 6,6. Briefly, polyamides are products that contain recurring amide groups as integral parts of the main polymer chains.

### Polyethylene Ionomers

Polyethylene ionomers may be used to form layers in the packaging of the invention. Polyethylene ionomers include poly(ethylene-co-methacrylic acid) copolymers sold under the trademark Surlyn®, as well as poly(ethylene-co-acrylic acid) available as Nucrel® copolymers. Usually the ionomers are in sodium salt form.

### Examples

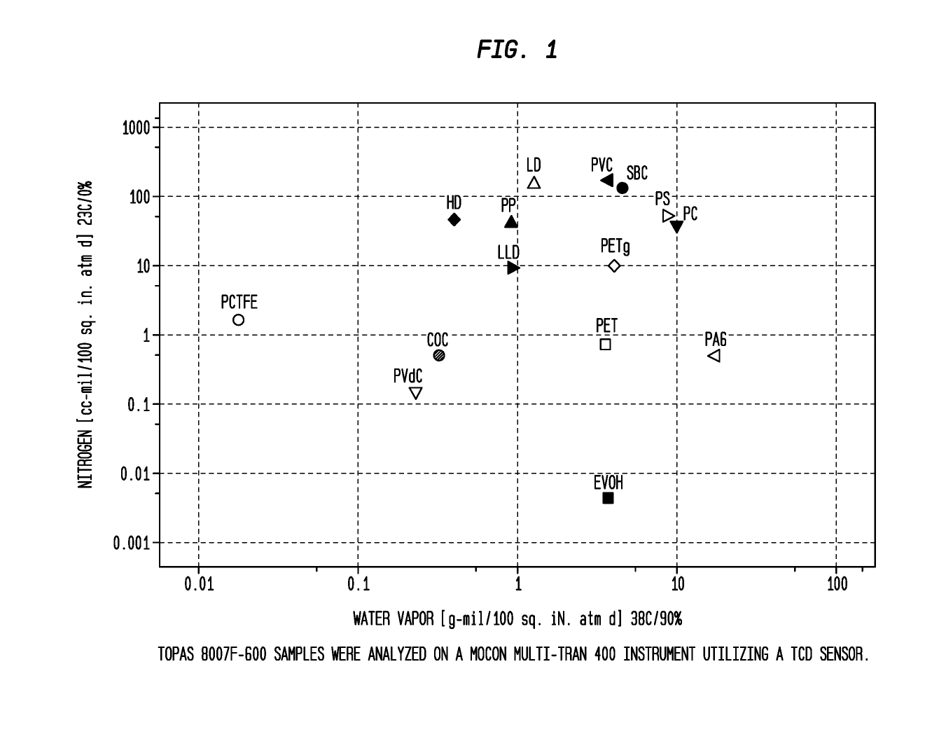

There is shown in FIGS. 1 to 4 the permeability of various polymer films with respect to oxygen, nitrogen, helium and water vapor. Permeability is a property of the material and is the product of the permeance and thickness. Units of permeability are mass (or volume) times thickness divided by area times time and pressure, as seen in FIGS. 1 to 4. In FIGS. 1 to 4:

COC refers to amorphous cycloolefin copolymer;

E-140 refers to semi-crystalline cycloolefin copolymer elastomer;

EPDM refers to ethylene-propylene-diene rubber;

EVOH refers to ethylene vinyl alcohol copolymer;

HD refers to high density polyethylene;

LD refers to low density polyethylene;

LLD refers to linear low density polyethyelene;

PA6 refers to nylon 6;

PCT FE refers to polychlorotrifluoroethylene;

PC refers to polycarbonate;

PET refers to polyethylene terephthalate;

PETg refers to glycol-modified polyethylene terephthalate;

PP refers to polypropylene;

PS refers to polystyrene;

PVC refers to polyvinylchloride;

PVdC refers to polyvinylidenechloride;

SBC refers to polystyrene block copolymer;

SBR refers to styrene butadiene rubber;

TPE refers to thermoplastic elastomer; and

TPU refers to thermoplastic polyurethane elastomer.

It is seen in FIG. 1 that amorphous COC film has better or equal nitrogen barrier than films of most available polymers; nearly two orders of magnitude better than polyethylenes and polypropylenes and comparable to PET and nylon 6. Water resistance is much better than all polymers tested except for PVdC and PCTFE which are expensive and are considerably more difficult to process than COC materials.

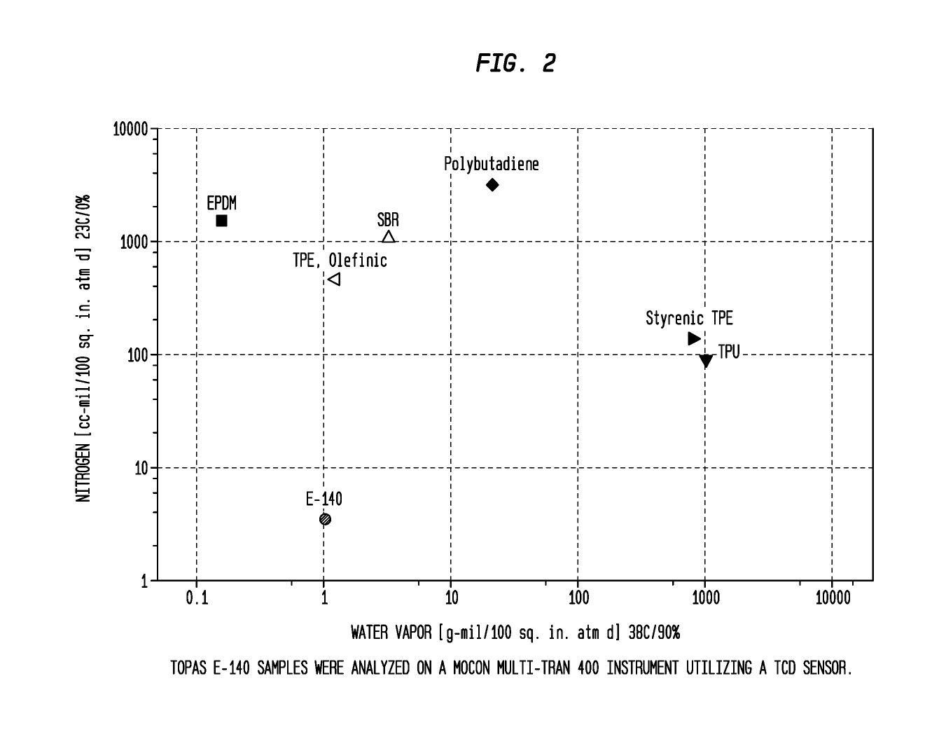

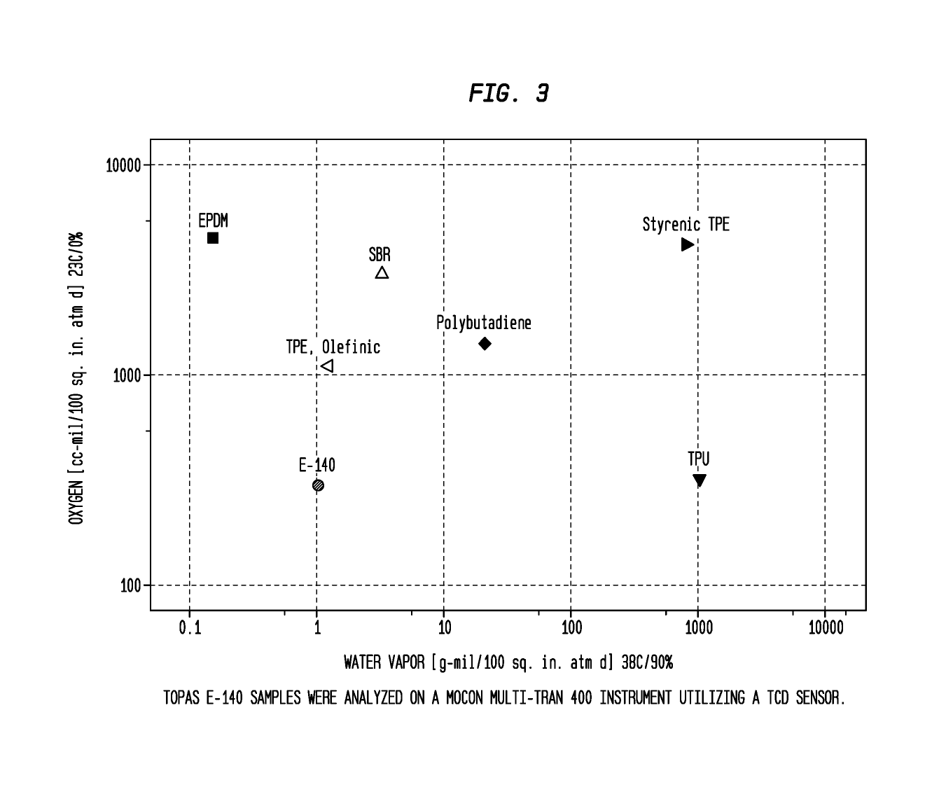

In FIG. 2 it is seen that COC elastomer has far superior nitrogen barrier than all of the elastomers tested and is among the most resistant to moisture penetration. FIG. 3 shows similar relationships for oxygen barrier and water resistance for the various elastomer films tested

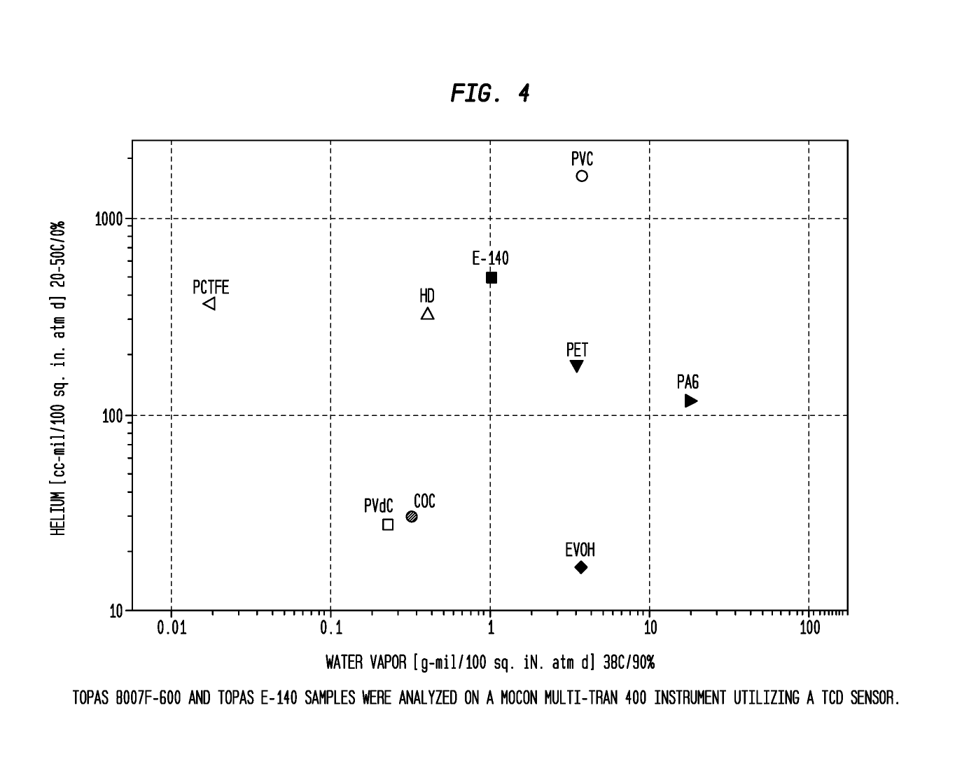

FIG. 4 shows that amorphous COC polymer films exhibit superior helium barrier, an order of magnitude better than HDPE and better moisture barrier performance compared to all but the halogenated polymer films.

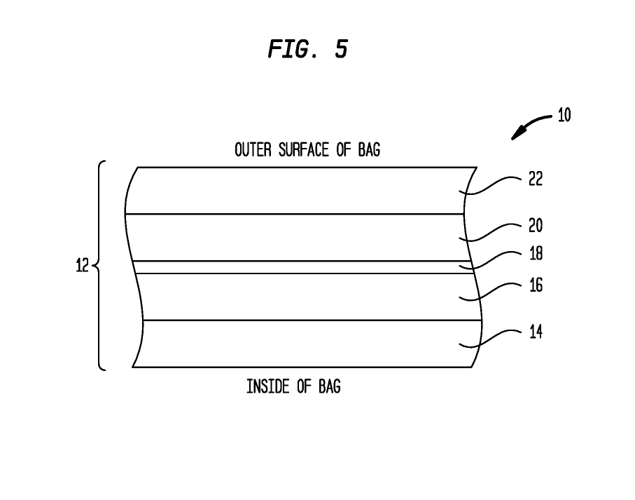

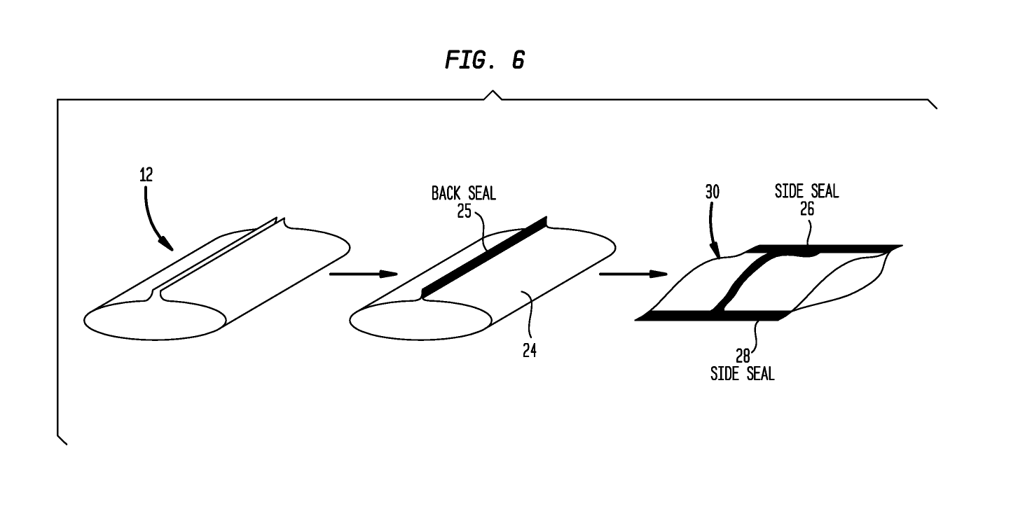

It is appreciated from FIGS. 1 to 4 that either COC amorphous copolymer or semi-crystalline elastomer and blends thereof with other polyolefins can greatly enhance the performance of controlled atmosphere structures such as nitrogen filled snack bags and the like, potentially increasing shelf life of packaged products up to an order of magnitude. An exemplary construction of the invention is discussed below in connection with FIGS. 5 and 6.

There is shown in FIG. 5 a sidewall 10 of a nitrogen inflated feed containing bag 30 (FIG. 6) of the invention. Sidewall 10 is made up of a multilayer film 12 including an inside layer 14 of COC copolymer or COC copolymer elastomer laminated (with or without a tie layer) to a layer 16 of metallized BOPP having a metal layer 18 of aluminum material on its outer surface. A layer 20 of LDPE is bonded to the aluminized surface with a bonding agent therebetween and is also bonded to another COC copolymer or COC elastomer film 22 with or without a bonding agent. While the illustrated structure is a laminate, it will be appreciated that the multilayer film could be produced by coextrusion using barrier layers such as EVOH in place of metal barrier layer 18.

Film 12 typically has an overall thickness of from 35 to 200 microns, typically from 55 to about 150 micron, more preferably from about 60-120 microns so as to be suitable for fabricating pillow-type flexible packaging, as is shown schematically in FIG. 6. The individual layers may have a thickness of from about 5 to 40 microns.

In FIG. 6, film 12 is formed into a tubular structure 24, provided with a back seal 25, side sealed at 26, 28 with transverse seals and filled with edibles such as potato chips and the like, as well as being inflated with nitrogen to replace air on the inside of the bag. Seals 25, 26, 28 may be fin-type seals or, in the case of seal 25, may be an overlapping seal since layer 14 is readily bondable with layer 22. In all cases, heat-sealing without a bonding agent is preferred for case of processing.

Further details concerning fabrication of bag 30 may be seen in U.S. Pat. No. 6,543,208 to Kobayashi et al. and U.S. Pat. No. 5,347,795 to Fukuda.

The inventive structure thus provides sealing with a low-permeability COC copolymer or COC copolymer elastomer composition which has a very low permeability with respect to moisture, nitrogen and other inert gasses, as seen above in connection with FIGS. 1 to 4. Other suitable controlled atmosphere products which may be made with alicyclic polyolefin barrier components include vacuum packed products, bubble wrap, inflated cushioning pillows for packaging, inflated footwear inserts, helium filled balloons, helium storage containers and the like, tires and other products where superior barrier gas and water vapor properties are desirable.

While the invention has been described in detail, modifications within the spirit and scope of the invention will be readily apparent to those of skill in the art. Such modifications are also to be considered as part of the present invention. In view of the foregoing discussion, relevant knowledge in the art and references discussed above in connection with the foregoing description including the Background of the Invention, the disclosures of which are all incorporated herein by reference, further description is deemed unnecessary. In addition, it should be understood from the foregoing discussion that aspects of the invention and portions of various embodiments may be combined or interchanged either in whole or in part. Furthermore, those of ordinary skill in the art will appreciate that the foregoing description is by way of example only, and is not intended to limit the invention.

What is claimed is:

1. Controlled-atmosphere flexible packaging comprising:
(a) a multilayer polymeric film heat-sealed to form an enclosure,
said multilayer film including an alicyclic polyolefin barrier layer forming a heat-seal; and
(b) a controlled atmosphere retained within said enclosure, said controlled atmosphere being selected from inert gas atmospheres.

2. The controlled atmosphere flexible packaging according to claim 1, wherein said inert gas atmosphere consists essentially of nitrogen.

3. The controlled atmosphere flexible packaging according to claim 1, wherein the nitrogen atmosphere within the enclosure is under positive gauge pressure.

4. The controlled atmosphere flexible packaging according to claim 1, wherein the multilayer polymeric film has a back heat seal and a pair of transverse heat seals thereby defining the enclosure, wherein the back heat seal and the transverse heat seals are formed with alicyclic barrier polyolefin.

5. The controlled atmosphere flexible packaging according to claim 1, wherein the transverse heat seals are formed by heat sealing alicyclic barrier polyolefin material together.

6. The controlled atmosphere flexible packaging according to claim 1, wherein the multilayer polymeric film is a laminated film including at least one metallized layer.

7. The controlled atmosphere flexible packaging according to claim 1, wherein the multilayer polymeric film includes at least one layer selected form polyethylene polymer layers and polypropylene polymer layers.

8. The controlled atmosphere flexible packaging according to claim 1, wherein the multilayer polymeric film includes a polyethylene ionomer layer.

9. The controlled atmosphere flexible packaging according to claim 8, wherein the polyethylene ionomer is poly(ethylene-co-methacrylic acid).

10. The controlled atmosphere flexible packaging according to claim 1, wherein the multilayer polymer film includes at least one polyamide layer.

11. The controlled atmosphere flexible packaging according to claim 1, wherein the enclosure houses a snack food in the controlled atmosphere.

12. The controlled atmosphere flexible packaging according to claim 1, wherein the alicyclic barrier layer comprises an amorphous cycloolefin polymer composition.

13. The controlled atmosphere flexible packaging according to claim 12, wherein the amorphous cycloolefin polymer composition comprises a COP.

14. The controlled atmosphere flexible packaging according to claim 12, wherein the amorphous cycloolefin copolymer composition comprises a COC.

15. The controlled atmosphere flexible packaging according to claim 14, wherein the COC is a norbornene/ethylene copolymer.

16. The controlled atmosphere flexible packaging according to claim 1, wherein the alicyclic polyolefin barrier layer comprises a partially crystalline, cycloolefin elastomer of norbornene and ethylene having a glass transition temperature, Tg, of less than 30° C., a crystalline melting temperature of less than 125° C. and a % crystallinity by weight of 40% or less.

17. The controlled atmosphere flexible packaging according to claim 1, wherein the alicyclic polyolefin barrier layer comprises a CBC.

18. In a controlled atmosphere enclosure having one or more polymeric components, the improvement comprising utilizing an alicyclic polyolefin barrier polymer.

19. The improvement according to claim 18, wherein the controlled atmosphere is selected from positive gauge pressure atmospheres, negative gauge pressure atmospheres, inert gas atmospheres or combinations thereof.

20. The improvement according to claim 19, wherein the controlled atmosphere is an inert gas atmosphere consisting essentially of nitrogen, argon, helium, carbon dioxide or combinations thereof.
